(19) United States
(12) Patent Application Publication
(10) Pub. No.: US 2026/0346779 A1
(43) Pub. Date: Nov. 5, 2026

(54) ROBOTIC MOBILE DELIVERY SYSTEM

(71) Applicant: Igor Sergeevich LERNER, Yaroslavl (RU)

(72) Inventor: Igor Sergeevich LERNER, Yaroslavl (RU)

(21) Appl. No.: 18/997,544

(22) PCT Filed: Feb. 6, 2023
(86) PCT No.: PCT/RU2023/000172

§ 371 Date: Jan. 22, 2025

(30) Foreign Application Priority Data
Jun. 15, 2022 (RU) 2022116076

(51) Int. Cl. B60P 3/11; B60P 1/44; B65G 1/137

(52) U.S. Cl. CPC B60P 3/11; B60P 1/4414; B65G 1/1371; B65G 2203/0216

(57) ABSTRACT

The invention relates to the field of logistics and multi-component robotic systems. A robotic mobile delivery system includes, disposed in a container or inside the body of a vehicle, a distribution unit (I) with a loading zone and an unloading zone, a storage unit (II), and a robotic unit (III), making up an automated delivery structure with a control subsystem that is linked by a wireless communication module to a central controller and to a cloud server for storing and transferring data. The storage unit (II) includes at least one robotic manipulator for gripping an article and bringing same into contact with non-detachable equipment and/or with aerial and ground delivery robots having a smart positioning and route planning system. The invention provides for greater automation and efficiency and permits the delivery of goods and correspondence by ground and air.

### TECHNICAL FIELD

The claimed invention relates to the field of multi-component robotic systems, which are designed to work in the field of logistics and can be used to deliver goods and correspondence to the population, including those living outside the boundaries of urban settlements, in particular, in settlements remote from civilization, where residents are in dire need of receiving postal services and the possibility of information exchange with the outside world.

### BACKGROUND OF THE INVENTION

It is not uncommon for postal or courier employees to spend time delivering parcels to addressees who live far from the main postal or courier route, for example, in hard-to-reach areas outside of a settlement. Parcels and correspondence must be delivered there either on foot, if there is no technical possibility of passage, or by car for one or more addressees. In addition, with traffic congestion in urban and other settlements, the delivery of parcels and correspondence still takes considerable time and requires a large labor force. Furthermore, in conditions of large-scale spread of viral and other diseases, the delivery of goods and correspondence by mobile, fully robotic systems becomes more and more relevant and safer.

Various technical solutions aimed at overcoming this problem are known from the prior art, including mobile delivery systems using unmanned aerial vehicles of various designs that perform the duties of delivery of various postal items to recipients in hard-to-reach areas.

Thus, document [1] (see US 2014254896, IPC B25J 9/00, published 11 Sep. 2014) discloses a mobile robotic system for delivery of postal items.

The system known from document [1] comprises: an item pickup and drop-off compartment and a mobile unmanned robot (drone) equipped with a processor configured to control the movement of the drone based on its geographical position and route data; a memory card configured to store at least payment data, purchase data and the route data; a screen and camera for interaction with a user; and a GPS module. The drone is controlled by a mobile application installed on a user device, such as a wristwatch, smartphone, augmented reality device.

The disadvantage of the above system known from document [1] is the possibility of delivery of goods having a limited range of dimensions, not exceeding the dimensions of the item pickup and drop-off compartment, and at a limited distance from a charging station, because it is made stationary.

Document [2] (see US2018196445, IPC B64C 39/02, published 12 Jul. 2018) discloses a parcel delivery system using drones based on a vehicle.

The vehicle of the parcel delivery system known from document [2] is predominantly an electric vehicle which is equipped with a cargo compartment with parcels and a special compartment on its roof to accommodate the drones, a charging station and a system for attaching the parcels to the drones. The compartment is equipped with a sliding roof that covers a robotic takeoff pad and opens when the drone takes off.

During parcel delivery, the vehicle and drone transmit telemetry information to a postal company to track the location and control the process of parcel delivery to recipients. Delivery by drone is carried out after a customer selects a specified option in a special mobile application installed on a user communicator.

The disadvantage of the system known from document [2] is the need to manually load the parcel into the specialized compartment of the drone for its subsequent delivery to a recipient, which does not allow to fully automate the delivery process, requiring constant human involvement in it.

Document [3] (see W02020104568, IPC G 06Q 10/08, published 28 May 2020) discloses a mobile system for goods delivery, which is the closest to the claimed invention from the point of view of technical essence and made in the form of a cargo vehicle.

The cargo vehicle known from document [3] comprises an autonomous cargo platform with a mobile cargo transporter, compartments for goods and unmanned aerial vehicles and ground delivery robots, a computer control unit, and communication means. The transporter comprises a controller configured to receive and transmit positioning data for processing thereof by the computer control unit.

The disadvantage of the mobile system known from document [3] is the possibility of goods delivery to a limited distance from a charging station, since its presence in the mobile system is not provided. In addition, moving the cargo compartments entirely along linear guides inside the mobile system to gateways or exit zones does not allow to optimally use the space inside the system to ensure maximum filling with goods for delivery and at the same time the possibility of their movement to the place of connection with the delivery robots.

### SUMMARY OF THE INVENTION

The technical problem to be solved by the presented technical solution is how to create a high-performance autonomous robotic mobile system for courier delivery of goods and correspondence, providing uninterrupted automated delivery of goods and correspondence, including to remote settlements, access to which is difficult due to their geographical location or seasonal climate features.

The technical result of the proposed invention, which is achieved when solving the above technical problem, is the realization of the purpose of designing a high-performance autonomous robotic mobile system for fully automated, with wide postal coverage, ground and airborne courier delivery of goods and correspondence.

The technical result is achieved by that a robotic mobile delivery system comprises a distribution unit (I) having a loading zone and an unloading zone, a storage unit (II), and a robotic unit (III), which are arranged in a container or inside a body of a vehicle, structurally separated by functions according to their purpose and connected during a technological process. The units (i), (ii), and (iii) form an automated delivery structure which is managed and controlled by a control subsystem comprising a hardware module having a processor linked via a wireless communication module to a central controller and a cloud-based data storage and transmission server. The system is characterized in that:
the loading zone of the distribution unit (I) comprises a loading board, and the unloading zone of the distribution unit (I) comprises an elevator platform movable along a transportation shaft having interfaces with transition portions of the floor and ceiling compartments of the robotic unit (III), as well as with the transition portion of the storage unit (II), and at least one hatch;
the storage unit (II) comprises at least one mobile rack-type structure comprising cells and equipped with a movable two-axis table in a ceiling portion, the table being connected by means of a vertically oriented post to a movable spherical support placed in a floor portion, wherein the vertical post carries a movable robotic manipulator configured to pick up an article for its subsequent positional contact with non-separable equipment and/or airborne and ground delivery robots;
the floor and ceiling compartments of the robotic unit (III) are equipped with landing service areas for ground and airborne delivery robots, each of which has an intelligent positioning and route planning system interacting with the control subsystem and determining a navigation route to a destination, providing for the possibility of mutual information exchange with authorized users.

According to one embodiment, the loading zone or the robotic manipulator is equipped with an article identification device (e.g., barcode or QR code scanning device) in order to perform double verification of the article sent for delivery or to confirm the identification of the article packed directly in the mobile delivery system.

According to one embodiment, the storage unit is equipped with an automatic article packaging device.

According to one embodiment, the elevator platform is equipped with an actuator configured as an electric drive equipped with a piston having a pusher and a gripping device to move the article from the elevator platform to any of the compartments of the mobile delivery system or to move the article to the cargo compartment of the ground delivery robot.

In one embodiment, the elevator platform is equipped with a means for photo and video control of the article located on it and/or scales installed directly under the platform of the elevator platform in order to control the weight of the platform itself and the platform with the article.

It is expedient if the storage unit is connected to the floor compartment of the robotic unit with the ground delivery robots by means of an opening with a door having an automatic locking mechanism.

The above-given combination of known and novel features is not disclosed in the prior art, and the proposed technical solution involves an inventive step and allows to increase the process of automation of courier delivery of goods, especially to remote and hard-to-reach settlements, and also allows to ensure maximum optimization of routes and time of delivery of goods and exclude cases when delivery by means of drones alone is impossible due to the presence of natural or artificial obstacles (trees, dead ends) or weather conditions (heavy rains, strong winds, etc.) or the article is large enough to be delivered by drone, or, conversely, in cases where delivery by ground couriers alone is impossible due to natural or artificial ground obstacles.

### BRIEF DESCRIPTION OF DRAWINGS

FIG. 1 shows a schematic side view of the proposed system, in which a distribution unit (I) with loading and unloading zones, a storage unit (II) and a robotic unit (III) forming an automated delivery structure are presented;

FIG. 2 shows a schematic top view of the distribution unit (I) with the loading and unloading zones and the storage node (II);

FIG. 3 shows a schematic top view of the robotic unit (III) with ground delivery robots, their charging points in the robotic unit and areas of their placement on chargers;

FIG. 4 schematically shows rack-type mobile units with cells filled with goods and installed in the storage unit (II) of the mobile delivery system;

FIG. 5 shows a schematic side view of the mobile delivery system, in which a robotic manipulator mechanism that controls the spatial arrangement of the objects of the proposed system in the storage unit (II) and the distribution unit (I) is presented;

FIG. 6 shows a detailed side view of the robotic manipulator mechanism;

FIG. 7 schematically shows a part of the robotic unit (III), in which airborne delivery robots are located on recharge, as well as shows a second robotic mechanism that controls the spatial arrangement of the airborne delivery robots;

FIG. 8 schematically shows a process for filling and loading the rack-type mobile units with article-filled cells into the mobile delivery system;

FIGS. 9, 10, 11, 12 schematically show a process for moving an article from the storage unit (II) on a transportation shaft with an elevator platform to a ceiling compartment where the airborne delivery robots of the robotic unit (III) are located, and to an exit area device for the airborne delivery robots;

FIGS. 13, 14, 15, 16 schematically show a process for returning the airborne delivery robot to the mobile delivery system after delivery of the article, its landing in the exit zone and a process for moving it with the second robotic mechanism controlling the spatial arrangement of the airborne delivery robots into the ceiling compartment of the robotic unit (III) for storage and recharging;

FIG. 17 schematically shows a method for identifying goods in the cells of the rack-type mobile unit and transmitting information thereof to a central controller.

FIG. 18 schematically shows a drop-off plan and routes of ground and airborne delivery robots.

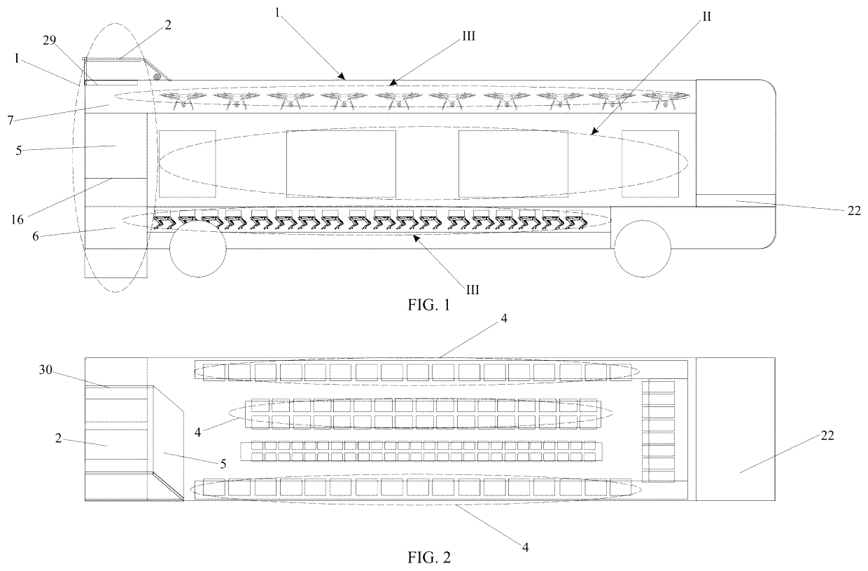

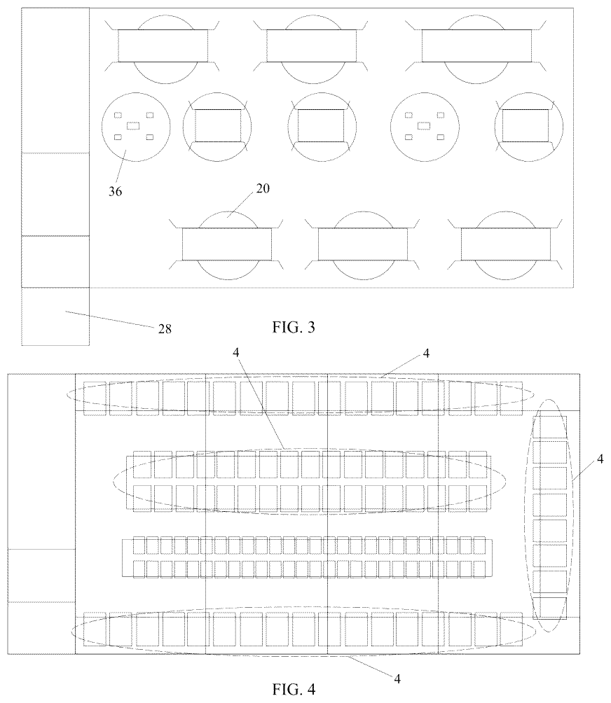

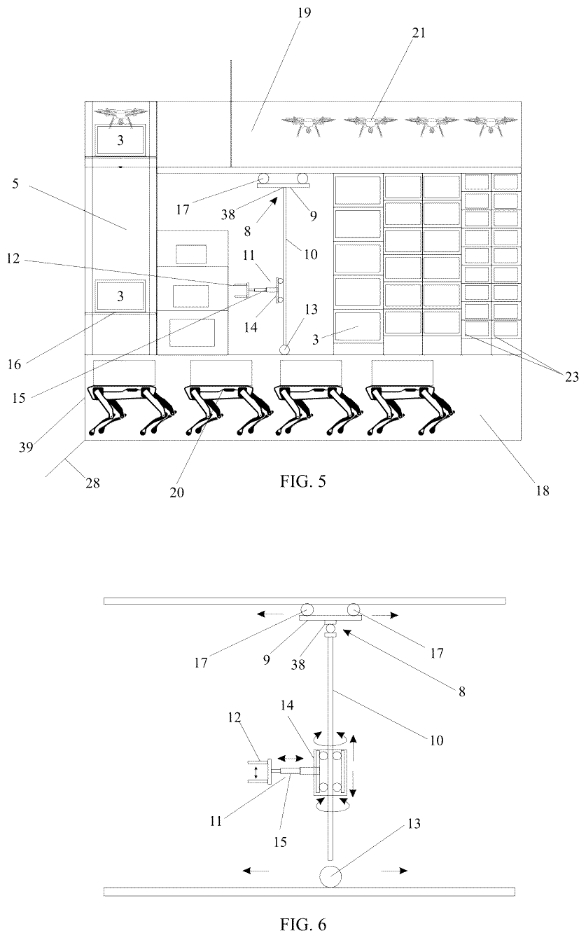

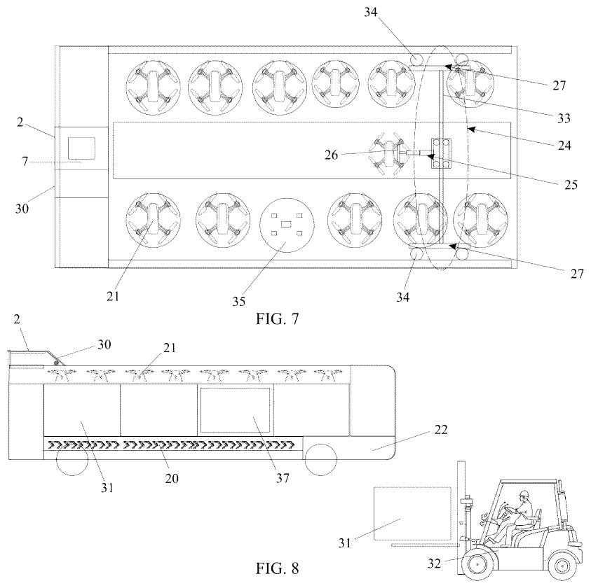

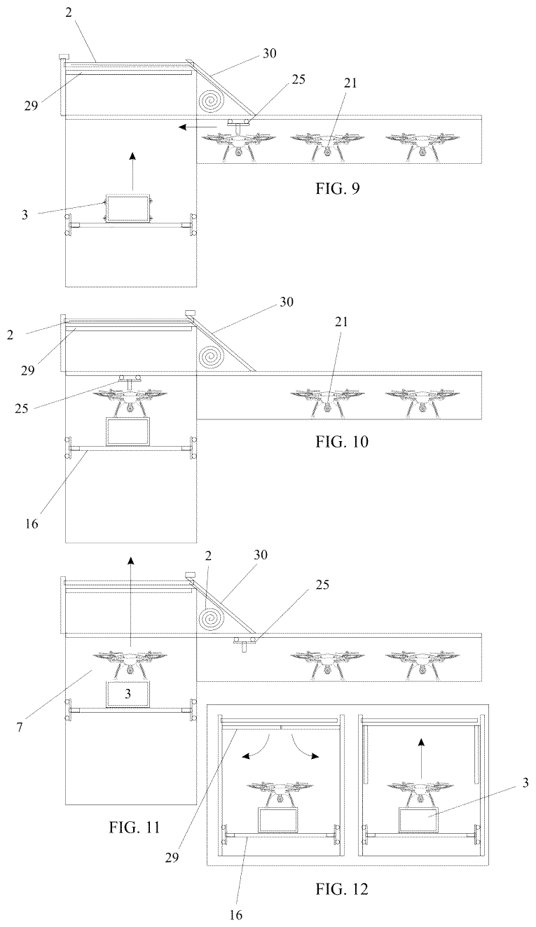

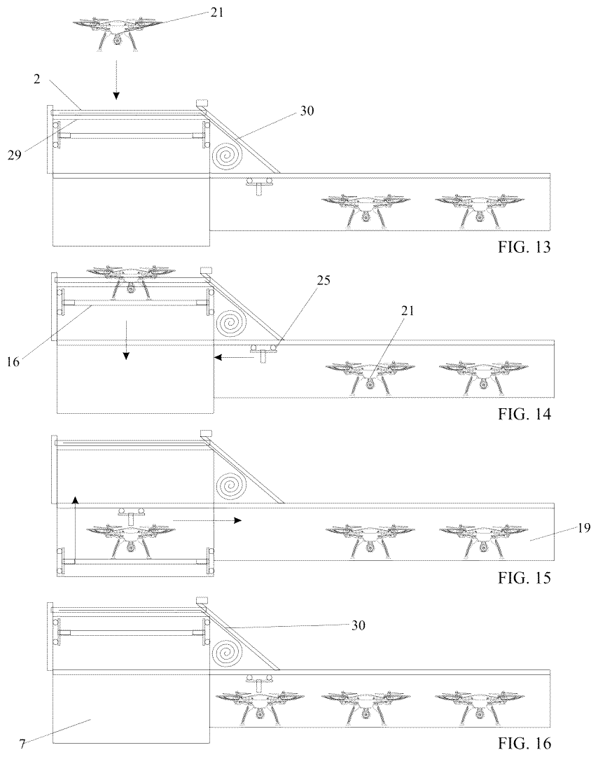

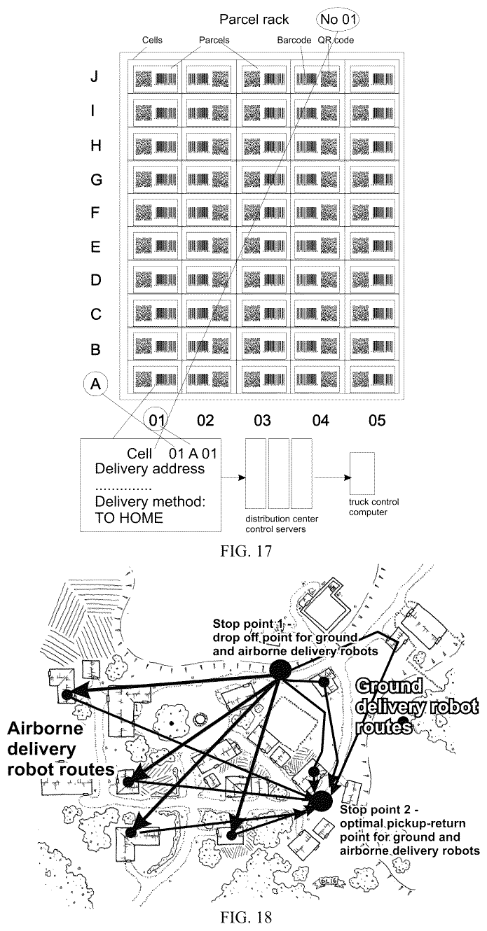

### DETAILED DESCRIPTION OF THE INVENTION

The proposed invention is explained by a specific exemplary embodiment, which, however, is not the only possible one, but clearly demonstrates the achievement of the given technical result by the specified set of essential features, as well as the solution of the existing technical problem. In describing the exemplary embodiment, specific nomenclature is used for the sake of clarity. However, the invention is not intended to be limited to the specific nomenclature so selected. Those skilled in the art will recognize that other equivalent parts and mechanisms or algorithms may be used which do not depart from the scope of the invention.

The above-listed figures show the following parts and elements of the proposed mobile delivery system:
I—distribution unit;
II—storage unit;
III—robotic unit;
1—vehicle;
2—external hatch;
3—article;
4—rack-type mobile structure with cells;
5—transportation shaft;
6—floor gateway part;
7—ceiling gateway part;
8—two-axis working table;
9—working platform of the table;
10—vertically oriented post;
11—robotic manipulator;
12—tool for gripping and holding goods;
13—spherical support;
14—base of the robotic manipulator;
15—retractable mechanism of the robotic manipulator;
16—elevator platform;
17—servo drives;
18—floor compartment;
19—ceiling compartment;
20—ground delivery robot;
21—airborne delivery robot;
22—control subsystem;
23—cells;
24—second two-axis working table;
25—small robotic manipulator;
26—gripping device of the small robotic manipulator;
27—working platforms of the table;
28—ramp for ground delivery robot;
29—internal hatch;
30—airflow barriers;
31—separate rack-type mobile unit;
32—lifting machine;
33—second horizontal crossbar;
34—servo-driven elements;
35—storage and recharging area for airborne delivery robots;
36—storage and recharging area for ground delivery robot;
37—loading board;
38—first horizontal crossbar;
39—loading and unloading hatch.

In summary, the robotic mobile delivery system comprises a distribution unit (I) with loading and unloading zones, a storage unit (I) and a robotic unit (III), which are arranged in a container or a body of a vehicle 1, structurally separated by functions according to their purpose and connected during a technological process. These units form an automated delivery structure with the possibility of centralized and local remote control and management of the structure and its autonomous components.

The distribution unit (I) comprises two zones:
loading,
unloading.

The loading zone is arranged in an end or side part of the container or the body of the vehicle 1 and includes at least one loading board 37, which opens automatically, and through which the vehicle 1 is loaded with separate rack-type mobile units 31.

The loading zone may be equipped with an identification device (like a barcode scanning device) for the rack-type mobile units 31, which identifies the rack-type mobile units 31 with articles 3 placed in their cells 23.

The unloading zone is made as a transportation shaft 5, inside which an elevator platform 16 (pneumatic, electric, hydraulic or other) installed therein moves. In this case, the transportation shaft 5 has interfaces with the transition portions of the floor and ceiling compartments of the robotic unit (III), as well as with the transition portion of the storage unit (II).

The storage unit (II) comprises at least one rack-type mobile structure 4 formed from the rack-type mobile units 31 with the cells 23, and a two-axis working table 8 located above it in the ceiling part. The table 8 has a first horizontal crossbar 38 moving from the end part of the container or the body of the vehicle body 1 to its front part by means of servo drives 17 along the guides fixed along the ceiling part of the storage unit II. A vertical post 10 is attached to a working platform 9 of the two-axis working table 8 which is configured to move along the first horizontal crossbar 38 due to the servo drives. The vertical post 10 serves as a base for vertical movement of a robotic manipulator 11 along it, with the robotic manipulator being equipped with a tool 12 for gripping and holding goods (a clamp with lateral gripping parts) and computer vision elements (video cameras, lidars, etc.). The lower part of the vertical post 10 rests on a spherical support 13 (a wheel, a ball, a drum, a roller, etc.), which rests against the floor of the storage unit II. Thus, the vertical post 10 of the two-axis working table 8, resting on the spherical support 13, can move along the floor of said unit, which together with the upper fastening to the working platform 9 of the two-axis working table 8 forms a stable vertical system that can move throughout the room with a sufficiently high positional accuracy. As has already been indicated, the two-axis working table 8 structurally consists of the working platform 9 with the servo drives 17 providing movement along the first horizontal crossbar 38, which is also equipped with the servo drives 17 providing movement along the guides fixed in the ceiling part of the storage unit II.

The robotic manipulator 11 is attached to the vertical post 10 with its base 14, which allows its base to move up and down. Additionally, this base can rotate around the axis of the vertical post 10. Such rotation by 360 degrees allows the robotic manipulator 11 to reach any point of the racks and the storage unit II at any angle. In this case, the robotic manipulator 11 is additionally equipped with a retractable mechanism 15 which allows to extend and shorten the length of the robotic manipulator 11 and to grip articles 3, thereby providing an additional degree of freedom. Any article 3, gripped and held by the robotic manipulator 11, can be moved through the transition portion of the storage unit (II) to the elevator platform 16 of the transportation shaft 5. Then, the article 3 on the elevator platform 16, moving along the transportation shaft 5 coupled with the transition portions of the floor and ceiling compartments of the robotic unit (III), can be delivered to the transition portions of the floor and ceiling compartments of the robotic unit (III).

In the storage unit II, in the immediate vicinity of the transportation shaft 5 of the distribution unit (I), a device for automatic packaging of articles 3 can be installed, where, if necessary, their packaging can be carried out.

The automatic packaging device for articles can be made as a motor-driven device for packaging with stretch film, comprising a rotary platform on which the article to be packaged is installed, a vertical clamping device lowered from above onto the article to secure the article and having a rotary mechanism, a mobile motorized carriage for preliminary stretching of the stretch film, a horizontal rotary clamp allowing the article to be intercepted and turned over during the packaging process.

Any article 3, gripped and held by the robotic manipulator 11, can be moved to the rotary platform of the automatic packaging device for subsequent packaging in accordance with the software embedded in the automatic packaging device.

After completion of packaging, the packaged article 3 gripped and held by the robot manipulator 11 can be moved through the transition portion of the storage unit (II) to the elevator platform 16 of the transportation shaft 5. Then, the article 3 on the elevator platform 16, moving along the transportation shaft 5 coupled with the transition portions of the floor and ceiling compartments of the robotic unit (III), can be delivered to the transition portions of the floor and ceiling compartments of the robotic unit (III).

The robotic unit III includes floor and ceiling compartments 18 and 19 with storage and recharging areas (36, 35) for intelligent ground and airborne delivery robots 20, 21 equipped with an intelligent positioning and route planning system for determining a navigation route to a destination, the robots being made with the possibility of mutual information exchange with authorized users to maintain communication interaction in a certain area of a terrain.

The control and monitoring of the operation of the components of the system, both as a whole and separately, is carried out using a control subsystem 22 comprising a hardware module with a processor connected via a wireless communication module to a central controller and a cloud-based data storage and transmission server.

In a preferred embodiment, intelligent airborne delivery robots 21 are made as drones using propellers for movement. Known developments can be used as the airborne delivery robots 21, in particular, models from Aerones (see htps://rg.ru/2017/05/15/na-video-sniali-pervyj-pryzhok-cheloveka-s-drona.html).

Intelligent ground delivery robots 20 are equipped with manipulator legs, wheel pairs or caterpillar movers for movement over rough terrain. Well-known developments can be used as the ground delivery robots 20, in particular, robots Marathon Robotics or Gita, Piaggio (see htp://robotrends.ru/robopedia/ulichnye-roboty-kurery).

The ground 20 and airborne 21 delivery robots are equipped with a processor for data control and processing, a wireless communication module, a global satellite positioning and navigation module, a circular view camera that allows studying routes and identifying recipients, lidars and other positioning means.

Each cell 23 for placing and storing the article 3 in the separate rack-type mobile unit 31 has its own identification number which is applied to the surface of the cell and entered into the memory of the central controller and stored on the cloud-based data storage and transmission server. The cells are installed in the separate rack-type mobile unit 31. The package of each article 3 has a code applied thereon and identifying the specified article, information about a recipient, delivery address and other necessary parameters (for example, a barcode or QR code). This allows systematizing information about the article 3 stored in each cell 23 and its addressee. Information about the identified cells 23 and the articles 3 located in them is entered into the memory of the central controller at the time of loading the articles 3 into the cells 23 of the separate rack-type mobile unit 31 in a sorting center. Each separate rack-type mobile unit 31 also has its own identification number entered into the memory of the central controller and applied to its surface.

Identification data on the positioning location of the separate rack-type mobile unit 31 in the rack-type mobile structure 4 are entered into the memory of the central controller at the time of loading the separate rack-type mobile units 31 into the mobile delivery system and forming the rack-type mobile rack-type structure 4 in the storage unit (II) through the loading zone.

The specified information is transmitted to the robotic manipulator 11 which will pick up a required article 3 from a specific cell 23 and place it in the storage compartment of the ground delivery robot 20 or on the elevator platform 16 for moving the article 3 along the transportation shaft 5 into the transition portions of the floor and ceiling compartments of the robotic unit (III) for the purpose of further transfer to the airborne 21 or ground 20 delivery robot. When transferring the article 3 to the airborne 21 or ground 20 delivery robot, the information identifying the article 3 is sent to the processor for controlling and processing the data of the corresponding ground 20 or airborne 21 delivery robot, thanks to which they receive information about the specific article 3 and its delivery address.

According to one embodiment, the tool 12 for gripping and holding articles in the robotic manipulator 11 can be equipped with its own identification device (for example, a scanner of barcodes or QR codes, numbers, or a video camera that allows codes or numbers to be read). Thus, when the hardware module with the processor of the control subsystem 22 sends a corresponding command, the robotic manipulator 11 can, by scanning the codes from the packages of the article 3 or the surface of the separate rack-type mobile unit 31, identify the article 3 or the autonomous separate unit 31 in the rack-type mobile structure 4.

Inside the storage unit II and the distribution unit I, the articles 3 are moved using the robotic manipulator 11 which is equipped with a gripping mechanism in the form of the gripping and holding tool 12. Upon the arrival of the mobile delivery system in a delivery zone, the control subsystem 22 sequentially issues commands to the robotic manipulator 11 to remove a specific article 3 from the cell 23 of the rack-type mobile structure 4 and move it to the packaging device or directly to the unloading zone of the distribution unit (I) for the purpose of transferring it to the elevator platform 16 or placing it in the cargo compartment of the ground delivery robot 20 if the storage unit is connected to the floor compartment 18 via an opening with a door.

If the robotic manipulator 11 transfers the article 3 to the elevator platform 16, the hardware module of the control subsystem 22 sends a command to the elevator platform 16 to move the article 3 to the transition portion of the floor or ceiling compartments of the robotic unit (III) for ground delivery or for airborne delivery, respectively.

The ground delivery robots 20, which are located in their storage and recharging areas 36 in the floor compartment 18 of the robotic unit III, move as they are activated by the hardware module of the control subsystem 22 inside the floor compartment 18 due to their own movement devices (manipulator legs, wheel pairs or caterpillar movers) along passages specially allocated for this purpose, move towards the elevator platform 16 or into a floor gateway part 6.

The airborne delivery robot 21 move inside the ceiling compartment 19 with the help of a small robotic manipulator 25. The small robotic manipulator 25 is fixed in the upper part of the ceiling compartment 19 on a second horizontal crossbar 33, the movement of which along said compartment is carried out by means of a second two-axis movable table 24. Structurally, the second two-axis working table 24 consists of working platforms 27, the movement of which along the guide beams along the ceiling compartment 19 is ensured by means of a group of servo-driven elements 34.

The small robotic manipulator 25 is mounted on the second horizontal crossbar 33 in such a way that, due to the servo-drives, it can move along said crossbar. This ensures the possibility of operation of the small robotic manipulator 25 in all parts of the ceiling compartment 19. The small robotic manipulator 25 is equipped with a gripping docking device 26 for holding the airborne delivery robots 21. The device 26 has a base, a telescopic part and an actual working part in the form of docking magnetic elements (clamps), the action of which is controlled by the control subsystem 22.

Using the gripping device 26 (can be made in the form of a clamp with lateral gripping parts), the small robotic manipulator 25 takes a specific airborne delivery robot 21 activated by the hardware module of the control subsystem 22 from its storage and recharging area 35 and moves it to the transition portion of the ceiling compartment of the robotic unit (III), where the article 3 to be delivered is delivered through the transportation shaft 5 for the purpose of its subsequent attachment to the airborne delivery robot 21. After the gripping holding mechanism of the airborne delivery robot 21 itself has attached the article 3 to it, the small robotic manipulator 25 releases this airborne delivery robot 21 and returns for the next one.

The transition portion of the ceiling compartment of the robotic unit (III) is a ceiling gateway part 7. It is in the ceiling compartment 19 of the robotic unit (III) directly above the transportation shaft 5 and comprises two hatches. On command from the hardware module of the control subsystem 22, the first (internal) hatch 29 opens with sliding mechanisms, after which the elevator platform 16 lifts the airborne delivery robot 21 with the article 3 attached to it to the external hatch 2. A corresponding command is sent to the hardware module of the control subsystem 22 that the airborne delivery robot 21 with the article 3 is ready to be released from the vehicle 1, and then, on command from the control subsystem 22, the external hatch 2 opens to release the airborne delivery robot 21.

The elevator platform 16 is made of a non-magnetic material, such as impact-resistant plastic, under which electromagnets are equipped that are activated immediately after the completion of the fixation of the article 3 by the airborne delivery robot 21 to be released from the mobile delivery system, or at the time of landing of the airborne delivery robot 21 on the elevator platform 16 after the delivery of the article 3 (i.e., during takeoff or landing). The electromagnets fix the airborne delivery robot 21, the base or lower parts of which are equipped with similar electric magnets activated at the time of takeoff and landing. The outer hatch 2 of the ceiling gateway part 7 is made according to the principle of a roller blind. There are airflow barriers 30 installed on the roof of the mobile delivery system in front of the external hatch 2, with the barriers being structural elements of the mobile delivery system that are made of weather-resistant materials (metal, plastic, other polymer, etc.) in the form of plates protecting against air flows and possibly having a streamlined shape. The barriers are intended to protect the airborne delivery robot 21 during takeoff and landing.

The lower part of the airborne delivery robot 21 is equipped with an article-attracting device 3 (for example, a device having suction cups or a magnetic device) and automatic clamps that secure the article from below. According to one embodiment, a cargo compartment (made of metal or other impact-resistant material) is equipped in the lower part of the airborne delivery robot 21, inside which an article-attracting device (for example, a device with suction cups or a magnetic device) is installed, while the bottom of the cargo compartment is made in the form of automatically sliding doors on a magnetic or other lock.

The upper part of the ground delivery robot 20 is equipped with a cargo compartment configured as a protected box (made of metal or other impact-resistant material), which can be divided into several sections for the simultaneous delivery of several articles. Each of the sections is separated from the other sections and is closed by a special door with a lock (for example, magnetic). This lock can only be opened by the recipient of the article, by sending a command from a mobile device through installed software, or through communication channels, such as Bluetooth, NFC and others, in direct contact between the recipient of the article and the ground delivery robot 20.

The information exchange of the airborne 21 or ground 20 delivery robot with authorized users, as well as with the control subsystem 22, is carried out using the wireless communication module.

The article 3 is moved from the elevator platform 16 to the cargo compartment of the approaching activated ground delivery robot 20 by means of an actuator in the form of an electric drive equipped with a piston with a pusher and with a gripping device and installed on the elevator platform 16. Alternatively, the ground delivery robot 20 with the help of its own movement devices enters the approaching elevator platform 16, which together with the ground delivery robot 20 moves to the storage unit (II), where the robotic manipulator 11 places the article 3 in the cargo compartment of the arrived ground delivery robot 20. After that, the ground delivery robot 20 with the article 3 returns on the elevator platform 16 to the floor compartment 18 and moves to the gateway part 6 of the unloading zone.

The transition portion of the floor compartment of the robotic unit (III) is the floor gateway part 6 of the unloading zone. It is in the floor compartment 18 of the robotic unit (III) in the immediate vicinity of the transportation shaft 5 and comprises a loading and unloading hatch 39. The loading and unloading hatch 39 is opened using lifting mechanisms when this process is initiated by a user (to receive the article 3 directly in the mobile delivery system) or by the hardware module of the control subsystem 22 to release the ground delivery robot 20 with the article 3.

The floor gateway part 6 can be equipped with an additional internal hatch in order to prevent foreign objects or persons from entering the mobile delivery system. After the ground delivery robot 20, by means of its own movement devices, approaches the floor gateway part 6 to the loading and unloading hatch 39 or into the floor gateway part 6 from the elevator platform 16 by means of an actuator in the form of an electric drive equipped with a piston with a pusher, the article 3 subject to delivery directly from the mobile delivery system is moved, the additional internal hatch is closed by lifting mechanisms, thereby cutting off the space of the floor compartment 18 with the delivery robot 20 located therein or the article 3 from the floor gateway part 6. Thus, after opening the loading and unloading hatch 39, foreign objects or third parties will not be able to penetrate into the floor compartment 18 of the robotic unit (III).

The floor gateway part 6 is equipped with a ramp 28 for the exit of the ground delivery robots 20, which is a retractable platform that can be made of a solid material with electromagnetic elements under its lower surface to control the entry/exit of the ground delivery robots and can be extended at an angle.

The storage and recharging area 35 for the airborne delivery robots in the ceiling compartment 19 and the storage and recharging area 36 for the airborne courier robots in the floor compartment 18 of the robotic unit (III) include at least one slot or docking station for charging the battery of the airborne or ground delivery robot during its stay in the compartment.

The system can be equipped with an autonomous power supply system made in the form of stationary electric storage batteries, solar panels or wind turbines placed on the roof or on the outer walls of the container or the body of the vehicle 1 and connected via a cable connection and a converter to a docking station for charging the batteries of the delivery robots. It is possible to connect, via cables, the system to external chargers or the power grid.

The system operates as follows.

The system is usually loaded in sorting centers, in warehouses of transport companies, specialized loading and unloading areas, at sorting auto and railway stations.

The cells 23 filled with the goods are placed in the rack-type mobile unit 31, with the code on the package of the article 3 being pre-scanned for subsequent transmission of the received data (weight, dimensions, information about a sender and recipient, the number of the cell in which the article is placed) to a remote data storage and transmission server.

Loading of the separate mobile units 31 into the system is carried out mainly using lifting machines 32, which can be forklifts or robotic manipulators. To increase the level of automation during lifting and loading-distribution operations, a robotic manipulator comprising a gripper sleeve equipped with vacuum suction cups for gripping the article by a flat surface from the outside can be used.

After loading the system and starting the movement, the central controller determines, based on information from the cloud data storage and transmission server, the duration of the route as a whole and its individual sections, the estimated time of arrival at each point taking into account weather conditions and terrain, the duration of the stop at each point taking into account the time required to carry out courier delivery for a current settlement, due to which the estimated time of delivery of goods for each user can be determined.

The central controller wirelessly sends the calculated information to the cloud-based data storage and transmission server, from where, in turn, by accessing a cloud-based database, it sends notifications to users from the list of consignees in the form of messages in the installed software, push messages, messages in various messengers, SMS messages or other means of informing about the estimated time of arrival of the article 3 and the selected method of its delivery.

The advantage of the claimed mobile delivery system is the absence of the need to unload it in strictly designated places, as is required for traditional delivery of goods by road, rail or other means of transport. In this case, it is enough to stop at one of the points on the route that are closest to the settlement and permitted for parking, in order to perform delivery using the ground and airborne delivery robots. At the same time, moving the system inside the settlement is possible in the case when the consignee has chosen self-pickup from a certain point as a delivery method, or in the case when it is technically necessary and justified. For example, the delivery of especially valuable goods can be carried out through the floor gateway part 6 equipped with user identification systems, in the personal presence of the recipient.

Also, the delivery of goods directly through the floor gateway part 6 in the mobile system is carried out if it is impossible to deliver the article 3 to a specific recipient using the delivery robots.

The ground 20 and airborne 21 delivery robots are equipped with a processor for data control and processing, a wireless communication module, a global satellite positioning and navigation module, a 360-degree camera that allows studying routes and identifying recipients, lidars and other positioning means.

After the delivery system has been delivered to the delivery area of the articles 3, the hardware module of the control subsystem 22 gives successive commands to the robotic manipulator 11 to remove a specific article 3 from the cell of the rack-type mobile structure 4 in which it is stored and to transfer it to the device for automatic packaging of the article 3 (if it is installed in the delivery system and packaging is required) that is located in the storage unit II in the immediate vicinity of the transportation shaft 5 of the distribution unit (I). After the completion of packaging, the packaged article 3 gripped and held by the robotic manipulator 11 can be moved from the storage unit II to the distribution unit I, in particular, to its unloading zone-to the elevator platform 16 of the transportation shaft 5. Alternatively, the hardware module of the control subsystem 22 gives successive commands to the robotic manipulator 11 to remove a specific article 3 from the cell of the rack-type mobile structure 4 in which it is stored, and transfer it directly from the storage unit II to the distribution unit I, excluding the packaging of the article 3. Then, the hardware module of the control subsystem 22 gives commands to each corresponding ground delivery robot 20 about its activation and direction to the elevator platform 16.

After activation, the ground delivery robot 20 moves with the help of its own movement devices and actuators from the point of its location in the floor compartment 18 of the mobile delivery system (from a specific storage and recharging area of the ground delivery robots 36) to the elevator platform 16. The routes of movement of the robots inside the mobile delivery system are entered in advance into the control subsystem 22 and into the processors of the delivery robots. The route is selected by the hardware module of the control subsystem 22 of the mobile delivery system and communicated to the delivery robot depending on the storage point of the latter.

In the storage unit II, in the immediate vicinity of the transportation shaft 5 of the distribution unit (I), the robotic manipulator 11-depending on the option: delivery of the article 3 or issuance of the article 3 to a recipient on site-installs the article 3 in the cargo compartment of the ground delivery robot 20 that has arrived on the elevator platform 16, or places the article 3 on the elevator platform 16 for subsequent transfer of the latter to the floor gateway part 6.

Option for delivery to the recipient. The article 3 is installed by the robotic manipulator 11 in the cargo compartment of the ground delivery robot 20 that has arrived on the elevator platform 16, the cover of the cargo compartment of the ground delivery robot 20 is closed on command of the hardware module of the control subsystem 22, and the processor of the ground delivery robot 20 receives a signal about the completion of the process of loading the article 3. The elevator platform 16 returns the ground delivery robot 20 to the floor compartment 18 of the robotic unit II, and the ground delivery robot 20 moves to the floor gateway part 6 of the unloading zone. Alternatively, the article 3 installed by the robotic manipulator 11 on the elevator platform 16 is moved to the floor compartment 18 and is transferred from the elevator platform 16 to the cargo compartment of the ground delivery robot 20 that has approached the floor gateway part 6, with the help of the actuator of the elevator platform 16 in the form of an electric drive equipped with a piston with a pusher. The cover of the cargo compartment of the ground delivery robot 20 closes on command of the hardware module, and a signal about the completion of the article 3 loading process is transmitted to the processor of the ground delivery robot 20.

Next, the control subsystem 22 checks for the absence of foreign objects in the floor gateway part 6, then causes the loading and unloading hatch 39 to open, if necessary causes the ramp 28 for the exit of the ground delivery robots to move out and gives the command to the ground delivery robot 20 to go outside. A surveillance device (digital camera) is installed inside the gateway part 6. In addition, sensors/scales can be installed in the floor section of the gateway part 6, which signal the hardware module of the control subsystem 22 about the presence of foreign objects in the gateway area.

Option for issuing goods to a recipient on site. The user approaches the mobile delivery system and, using a mobile application or scanning a special code or another verification method, sends a command to the control subsystem 22 to issue the corresponding article 3. The robotic manipulator 11 activated by the control subsystem 22 picks up the article 3 from the cell 23 in the storage unit (II) and places it on the elevator platform 16. The elevator platform 16 moves the article 3 along the transportation shaft 5 to the floor compartment 18 of the robotic unit II. The article 3 is transferred from the elevator platform 16 to the floor gateway part 6 by means of the actuator of the elevator platform 16 in the form of the electric drive equipped with the piston with the pusher. Said movement of the article 3 can be performed in another way, for example, along guides located at an angle to the floor gateway part 6.

The control subsystem 22 checks for the absence of foreign objects in the floor gateway part 6, then causes the loading and unloading hatch 39 to open, and the recipient of the article takes the article 3 from the floor gateway part 6.

After the ground delivery robot 20 goes outside or after the recipient receives the article 3 from the floor gateway part 6, the loading and unloading hatch 39 closes on command from the control subsystem 22. And the procedure for releasing each ground delivery robot 20 with the article 3 is repeated as many times as there are articles to be delivered in the delivery area by the ground delivery robots 20.

After the last ground delivery robot 20 in a specific delivery zone is released, the hardware module of the control subsystem 22 causes the ramp 28 to move inside the mobile delivery system (retract the ramp 28).

Upon the return of each ground delivery robot 20 after delivery of the article 3, similar procedures in reverse order are repeated by command of control subsystem 22 to receive each ground delivery robot 20 into the mobile delivery system and move it to the storage and recharging area 36 for the ground delivery robots.

The delivery of goods directly through the ceiling gateway part 7 is carried out as follows.

After the mobile delivery system has been delivered to a delivery area, the control subsystem 22 gives successive commands to the small robotic manipulator 25 and a corresponding airborne delivery robot 21 about their activation and direction to the ceiling gateway part 7. Using the gripping device 26, the small robotic manipulator 25 picks up a specific airborne delivery robot 21 activated by the hardware module of the control subsystem 22 from its storage and recharging area 35 and then moves the airborne delivery robot 21, holding it from above, from its storage and recharging area 35 in the mobile delivery system to the ceiling gateway part 7. The robotic manipulator 11 picks up the article 3 to be delivered from the corresponding cell 23 of the rack-type mobile structure 4 according to its queue and delivery route. The hardware module of the control subsystem 22 gives a command to the robotic manipulator 11 about the transfer of the article 3 on the device for automatic packaging of the articles 3 (in case of its installation in the delivery system and the need to carry out packaging) that is located in the storage unit II in the immediate vicinity of the transportation shaft 5 of the distribution unit (I). After the completion of packaging, the packaged article 3 gripped and held by the robotic manipulator 11 can be moved from the storage unit II to the distribution unit I, in particular, to its unloading zone-to the elevator platform 16 of the transportation shaft 5. Alternatively, the hardware module of the control subsystem 22 gives sequential commands to the robotic manipulator 11 to remove a specific article 3 from the cell 23 of the rack-type mobile structure 4 and transfer it directly from the storage unit II to the distribution unit I, excluding the packaging of the article 3.

Next, the hardware module of the control subsystem 22 gives the command to the elevator platform 16 to move to the transition portion of the storage unit (II). The robotic manipulator 11 places the article 3 on the elevator platform 16 and, upon command from control subsystem 22, the elevator platform 16 moves the article 3 to the ceiling compartment 19 of the robotic unit III into the ceiling gateway part 7 to attach the article to the airborne delivery robot 21 waiting there. After the article 3 is attached and held by the airborne delivery robot 21, the small robotic manipulator 25 releases the airborne delivery robot 21 and sends a command to complete the process of attaching the article 3. Then, the control subsystem 22 checks for the absence of foreign objects on the inner hatch 29 (if the inner hatch 29 is equipped with sensors/scales that signal the control subsystem 22 about the presence of foreign objects on the inner hatch 29) and, upon command from the hardware module of the control subsystem 22, the inner hatch 29 opens by the sliding mechanisms. After that, the elevator platform 16 lifts the airborne delivery robot 21 with the article 3 attached to it to the external hatch 2. A corresponding command is sent to the control subsystem 22 that the airborne delivery robot 21 with the article 3 is ready to be released from the vehicle 1. Then, the hardware module of the control subsystem 22 checks for the absence of foreign objects on the external hatch 2 and causes the external hatch 2 to open. Surveillance equipment (digital cameras) is installed inside the gateway part 6 and directly on the external part of the vehicle 1, by analyzing data from which the control subsystem 22 determines the absence or presence of foreign objects using software.

Then, the hardware module of the control subsystem 22 activates the movement of the elevator platform 16 to the roof level of the mobile delivery system. After checking the weather conditions, the hardware module of the control subsystem 22 gives a command to deactivate the electromagnetic attachment of the airborne delivery robot 21 to the elevator platform 16 and activates the airborne delivery robot 21 for takeoff. After the takeoff of the airborne delivery robot 21, the elevator platform 16 is lowered from the ceiling gateway part 7, the external hatch 2 and the inner hatch 29 are successively closed as the elevator platform 16 is lowered by the command of the hardware module of the control subsystem 22. The corresponding algorithm of actions is repeated until a required number of airborne delivery robots 21 with articles is released from the mobile delivery system.

Upon the return of each airborne delivery robot 21 at the end of delivery, in the immediate vicinity of the mobile delivery system, the airborne delivery robot 21 sends signals to the hardware module of the control subsystem 22 about its readiness to land and move to the mobile delivery system. At the command of the hardware module of the control subsystem 22, the external hatch 2 and the inner hatch 29 are opened sequentially. Using the surveillance means, the hardware module of the control subsystem 22 checks for the absence of foreign objects on the elevator platform 16, gives the command to the elevator platform 16 to move to the level with the roof of the mobile delivery system and sends a signal to the airborne delivery robot 21 to return to the mobile delivery system. Then, the airborne delivery robot 21 descends onto the elevator platform 16, whereupon the magnetic fixation of the delivery robot to the elevator platform 16 occurs. After this, the hardware module of the control subsystem 22 gives the command to the elevator platform 16 to descend into the ceiling gateway part 7, and to sequentially close the external hatch 2 and the inner hatch 29. The airborne delivery robot 21 is picked up by the small robotic manipulator 25 and moved to its storage and recharging area 35. The process is repeated to receive each airborne delivery robot 21 returning after delivery into the mobile delivery system.

If the article 3 has not been delivered to the recipient for some reason, upon the return of the ground or airborne delivery robot with the article to the mobile delivery system, the control subsystem 22 uses the information received from the central controller and the cloud-based data storage and transmission server to carry out the procedure for detaching the article 3 from the ground or airborne delivery robot and return it to the cell 23 of the rack-type mobile structure 4 according to the algorithm for delivering the article 3, only carried out in reverse order.

In particular, the ground delivery robot 20 returns to the floor gateway part 6 via the ramp 28, the control subsystem closes the loading and unloading hatch 39 and directs the elevator platform 16 to the floor compartment 18. Then, the ground delivery robot 20 enters the elevator platform 16 and moves along the transportation shaft 5 to the storage unit (II). The robotic manipulator picks up the article 3 from the cargo compartment of the ground delivery robot 20 and returns the uncollected article 3 to the corresponding cell 23 of the rack-type mobile structure 4.

In the same way, the airborne delivery robot 21 with the uncollected article 3 descends onto the elevator platform 16, whereupon the delivery robot is magnetically fixed to the elevator platform 16. After this, the hardware module of the control subsystem 22 gives the command to the elevator platform 16 to descend into the ceiling gateway part 7, and to sequentially close the external hatch 2 and the inner hatch 29. The hardware module of the control subsystem 22 sends the command to the airborne delivery robot 21 to detach the article 3. Then, the airborne delivery robot 21 is picked up by the small robotic manipulator 25 and moved to its storage and recharging area 35. The elevator platform 16 moves the article 3 along the transportation shaft 5 to the storage unit (II). The robotic manipulator picks up the article 3 from the elevator platform 16 and returns the uncollected article 3 to the corresponding cell 23 of the rack-type mobile structure 4.

As indicated earlier, the system can be equipped on the outside with at least one video surveillance camera synchronized with the hardware module of the control subsystem 22. The data received from the camera are processed by the hardware module of the control subsystem 22 and allow for the safe launch of the airborne delivery courier 21, making sure that there are no natural or artificial obstacles in the form of wires, tree branches, etc., and also to process the data received from the camera to form and store a terrain map on a remote server, taking into account the relief, which can be used to form the next route and determine the estimated time of arrival at each of its points.

In addition, the camera with video recording capability and the wireless communication module allow video recording of the transfer of the article 3, which is sent to a remote server for storage for a specified amount of time.

Among other things, the camera can be used to record video during an attempt to steal an airborne or ground delivery robot and transmit broadcast data in real time to law enforcement agencies.

The airborne or ground delivery robots deliver goods to specified addresses, while the external data storage and transmission server sends notifications to users from the list of consignees in the form of messages in the installed software, push messages, messages in various messengers, SMS messages or other means of informing about the estimated time of arrival of the goods and the selected method of their delivery, and after receiving the article-a notification of the completion of delivery.

As an option, the system can be equipped with an additional external robotic manipulator for collecting inoperative unmanned vehicles.

The proposed invention can find wide application in industry, in particular in the field of delivery of goods and correspondence to areas remote from civilization.

1. A robotic mobile delivery system comprising:
a distribution unit (I) having a loading zone and an unloading zone;
a storage unit (II); and
a robotic unit (III);
wherein the distribution unit (I), the storage unit (II) and the robotic unit (III) are arranged in a container or inside a body of a vehicle, structurally separated by functions according to purpose thereof and connected during a technological process;
wherein the distribution unit (I), the storage unit (II) and the robotic unit (III) form an automated delivery structure which is managed and controlled by a control subsystem comprising a hardware module having a processor connected via a wireless communication module to a central controller and a cloud-based data storage and transmission server;
wherein the loading zone of the distribution unit (I) comprises a loading board, and the unloading zone of the distribution unit (I) comprises an elevator platform movable along a transportation shaft having interfaces with transition portions of floor and ceiling compartments of the robotic unit (III), as well as with the transition portion of the storage unit (II), and at least one hatch;
wherein the storage unit (II) comprises at least one mobile rack-type structure comprising cells and equipped with a movable two-axis table in a ceiling portion, the table being connected by a vertically oriented post to a movable spherical support placed in a floor portion, wherein the vertical post carries a movable robotic manipulator configured to grip an article for subsequent positional contact of the article with non-separable equipment and/or airborne and ground delivery robots;
wherein the floor and ceiling compartments of the robotic unit (III) are equipped with landing service areas for the ground and airborne delivery robots, each of which has an intelligent positioning and route planning system interacting with the control subsystem to determine a navigation route to a destination and configured to perform mutual information exchange with authorized users.

2. The robotic mobile delivery system of claim 1, wherein the distribution unit (I) is equipped with an automatic article packaging device.

3. The robotic mobile delivery system of claim 1, wherein the elevator platform of the distribution unit (I) is equipped with an actuator configured as an electric drive equipped with a piston having a pusher and a gripping device.

4. The robotic mobile delivery system of claim 1, wherein the elevator platform of the distribution unit (I) is equipped with a video surveillance or photo recording device.

5. The robotic mobile delivery system of claim 1, wherein the storage unit (II) is connected to the floor compartment of the robotic unit (III) with the ground delivery robots through an opening with a door having an automatic locking mechanism.
